(19) United States
(12) Patent Application Publication
(10) Pub. No.: US 2025/0238365 A1
(43) Pub. Date: Jul. 24, 2025

(54) ALLOCATING MEMORY BLOCKS FOR FEATURES DURING MEMORY DEVICE SETUP

(71) Applicant: Micron Technology, Inc., Boise, ID (US)

(72) Inventor: Nicholas T. HEATH, Pittsboro, NC (US)

(21) Appl. No.: 19/002,424

(22) Filed: Dec. 26, 2024

Related U.S. Application Data
(60) Provisional application No. 63/624,094, filed on Jan. 23, 2024.

(51) Int. Cl. G06F 12/02

(52) U.S. Cl. CPC G06F 12/0246; G06F 2212/7202

(57) ABSTRACT

Implementations described herein relate to allocating memory blocks for features during a setup of a memory device. In some implementations, the memory device may include memory and one or more components. The one or more components may be configured to allocate, during an initialization process, memory blocks in a memory for a set of features to be supported by the memory device, wherein an allocation is based on a user selection of the set of features. The one or more components may be configured to reallocate, during the initialization process, remaining memory blocks that are pre-allocated in the memory for non-selected features to a pool of memory blocks.

### CROSS REFERENCE TO RELATED APPLICATION

This Patent Application claims priority to U.S. Provisional Patent Application No. 63/624,094, filed on Jan. 23, 2024, and entitled “ALLOCATING MEMORY BLOCKS FOR FEATURES DURING MEMORY DEVICE SETUP.” The disclosure of the prior Application is considered part of and is incorporated by reference into this Patent Application.

### TECHNICAL FIELD

The present disclosure generally relates to memory devices, memory device operations, and, for example, to allocate memory blocks for features during a setup of a memory device.

### BACKGROUND

A non-volatile memory device, such as a NAND memory device, may use circuitry to enable electrically programming, erasing, and storing of data even when a power source is not supplied. Non-volatile memory devices may be used in various types of electronic devices, such as computers, mobile phones, or automobile computing systems, among other examples.

A non-volatile memory device may include an array of memory cells, a page buffer, and a column decoder. In addition, the non-volatile memory device may include a control logic unit (e.g., a controller), a row decoder, or an address buffer, among other examples. The memory cell array may include memory cell strings connected to bit lines, which are extended in a column direction.

A memory cell, which may be referred to as a “cell” or a “data cell,” of a non-volatile memory device may include a current path formed between a source and a drain on a semiconductor substrate. The memory cell may further include a floating gate and a control gate formed between insulating layers on the semiconductor substrate. A programming operation (sometimes called a write operation) of the memory cell is generally accomplished by grounding the source and the drain areas of the memory cell and the semiconductor substrate of a bulk area, and applying a high positive voltage, which may be referred to as a “program voltage,” a “programming power voltage,” or “VPP,” to a control gate to generate Fowler-Nordheim tunneling (referred to as “F-N tunneling”) between a floating gate and the semiconductor substrate. When F-N tunneling is occurring, electrons of the bulk area are accumulated on the floating gate by an electric field of VPP applied to the control gate to increase a threshold voltage of the memory cell.

An erasing operation of the memory cell is concurrently performed in units of sectors sharing the bulk area (referred to as “blocks”), by applying a high negative voltage, which may be referred to as an “erase voltage” or “Vera,” to the control gate and a configured voltage to the bulk area to generate the F-N tunneling. In this case, electrons accumulated on the floating gate are discharged into the source area, so that the memory cells have an erasing threshold voltage distribution.

Each memory cell string may have a plurality of floating gate type memory cells serially connected to each other. Access lines (sometimes called “word lines”) are extended in a row direction, and a control gate of each memory cell is connected to a corresponding access line. A non-volatile memory device may include a plurality of page buffers connected between the bit lines and the column decoder. The column decoder is connected between the page buffer and data lines.

### BRIEF DESCRIPTION OF THE DRAWINGS

FIG. 1 is a diagram illustrating an example system capable of allocating memory blocks for features during a setup of a memory device.

FIG. 2 is a diagram illustrating an example of a statically assigned block space for specific features of a memory device.

FIG. 3 is a diagram illustrating an example of allocating memory blocks for features during a setup of a memory device.

FIG. 4 is a diagram illustrating an example of different sets of features available for a memory device.

FIG. 5 is a flowchart of an example method associated with allocating memory blocks for features during a setup of a memory device.

### DETAILED DESCRIPTION

During a design of a memory device, such as a non-volatile memory device, a certain amount of memory blocks (e.g., NAND blocks) may be pre-allocated or set aside to support various features for the memory device. The features may include encryption, boot partitions, performance logs, health logs, and other types of various features. The features to be supported may be predetermined during the design of the memory device. The memory blocks associated with the features may be dedicated to storing information specific to the features, and other types of information may not be stored on these memory blocks. Memory blocks for each feature may be statically assigned during the design of the memory device, where a number of memory blocks for each feature may depend on the type and/or complexity of that feature. The features may be collectively referred to as user management requirements.

However, the features may require a substantial number of memory blocks, which may be permanently allocated at design time and remain allocated for a lifetime of the memory device, regardless of whether the features are used by an application. A memory block pool, or memory block budget, may be constrained at design time to accommodate support for the features. The support of the features may involve tradeoffs associated with endurance, overprovisioning, user space, and/or reliability. In other words, endurance, overprovisioning, user space, and/or reliability may be compromised in order to support the features. The tradeoffs may be more pronounced at lower capacity memory devices, which may have fewer spare memory blocks to spread across the feature requirements.

The tradeoffs needed to support the features may be disadvantageous when the features are not used by the application. Memory blocks may be pre-allocated for the features and cannot be used for other functions (e.g., read-write operations). Certain users may need to use only certain features, and in some cases, may not use a certain feature for which memory blocks are pre-allocated, which may result in those memory blocks not being utilized. As a result, certain memory blocks may be wasted, thereby degrading the performance of the memory device.

As an example, a user management feature set may include a feature associated with an encryption locking function, which may consume a certain number of memory blocks. When a user never plans to use the encryption locking function, the memory blocks set aside for that feature may be wasted, and the user must live with the tradeoff(s) made at design time to include support for the encryption locking function in the memory device.

In some implementations, a memory device may allocate, during an initialization process, memory blocks in a memory for a set of features to be supported by the memory device. The set of features may include one or more features associated with encryption, boot partitions, performance logs, or health logs. An allocation may be based on a user selection of the set of features. The allocation may be based on a command that is selected from a list of predefined commands, where each command on the list of predefined commands is associated with a predefined combination of features that are able to be supported by the memory device. The memory device may reallocate, during the initialization process, remaining memory blocks that are pre-allocated in the memory for non-selected features to a pool of memory blocks. The remaining memory blocks for the non-selected features may pre-allocated in the memory during a manufacturing phase of the memory device. The pool of memory blocks may be available for general purpose usage. The memory device may restrict modifications to a memory block allocation associated with the set of features after a completion of the initialization process.

In some implementations described herein, the memory device may receive, from a host processor, the command during a setup process for the memory device. The command may be associated with the user selection of the set of features to be supported by the memory device. The command may indicate that certain features are to be supported by the memory device. A lack of desired support may be assumed for features that are not associated with the command. The memory device may allocate, during the setup process and based on the command, memory blocks for the set of features. The memory device may refrain from allocating memory blocks for features that are not associated with the command. In other words, the memory device may only allocate memory blocks for selected features, and may not allocate memory blocks for features that are not selected.

As an example, four possible features may be available. A command received by the memory device may indicate that a first feature and a third feature should be enabled. The memory device may allocate memory blocks for only the first feature and the third feature. The memory device may not allocate memory blocks for a second feature and a fourth feature, which may be based on an assumption that the second feature and the fourth feature are not intended to be used by a user associated with the memory device.

In some implementations described herein, the memory device may receive, from the host processor, the command during the setup process for the memory device. The command may be associated with the user selection of the set of features to be supported by the memory device. The command may indicate that certain features are to be supported by the memory device. The lack of desired support may be assumed for features that are not associated with the command. The memory device may retain, based on the command, an allocation of memory blocks that are pre-allocated for features in the set of features. The memory device may assign memory blocks that are pre-allocated for features that are not associated with the command to a pool of memory blocks available for general purpose usage. In this case, during the design time of the memory device, memory blocks for all possible features may be allocated. Depending on the command received during the setup process, the memory device may only retain the allocation of memory blocks for the features associated with the command. For features that are not indicated in the command, the memory device may reassign or reallocate the corresponding memory blocks, such that these memory blocks may now be available for general use (e.g., for read-write operations).

As an example, during the design time of the memory device, memory blocks for four features may be allocated. These memory blocks may be pre-allocated during design time. During a setup process, a command received by the memory device may indicate that a first feature and a third feature should be enabled. The memory device may keep the pre-allocated memory blocks for the first feature and the third feature. The memory device may un-allocate memory blocks for a second feature and a fourth feature, based on the command, such that these memory blocks may become available to support general purpose operations (e.g., read-write operations). These memory blocks may no longer be pre-allocated for the second feature and the fourth feature.

In some implementations, by enabling a command that allows the user to select desired features to be supported at setup time, the memory device may only allocate (or retain a pre-allocation of) memory blocks for the desired features. Memory blocks that are associated with undesired features (e.g., features that are not intended to be used by a user associated with the memory device) may not be allocated (or a pre-allocation of such memory blocks may be removed). As a result, only memory blocks for features that are intended to be used may be set aside in the memory device, which may increase a number of memory blocks that are available for general purpose operations. When the user intends to use all possible features, such a design may not benefit the user because the memory blocks may be needed to support the features. However, when the user intends to use only a subset of possible features (e.g., the user does not intend to use certain features), the pre-allocation of those undesired features may be removed, thereby providing additional memory blocks that are usable for general purpose operations. In this case, since an additional number of memory blocks may be usable to support the general purpose operations, an overall performance of the memory device may be improved.

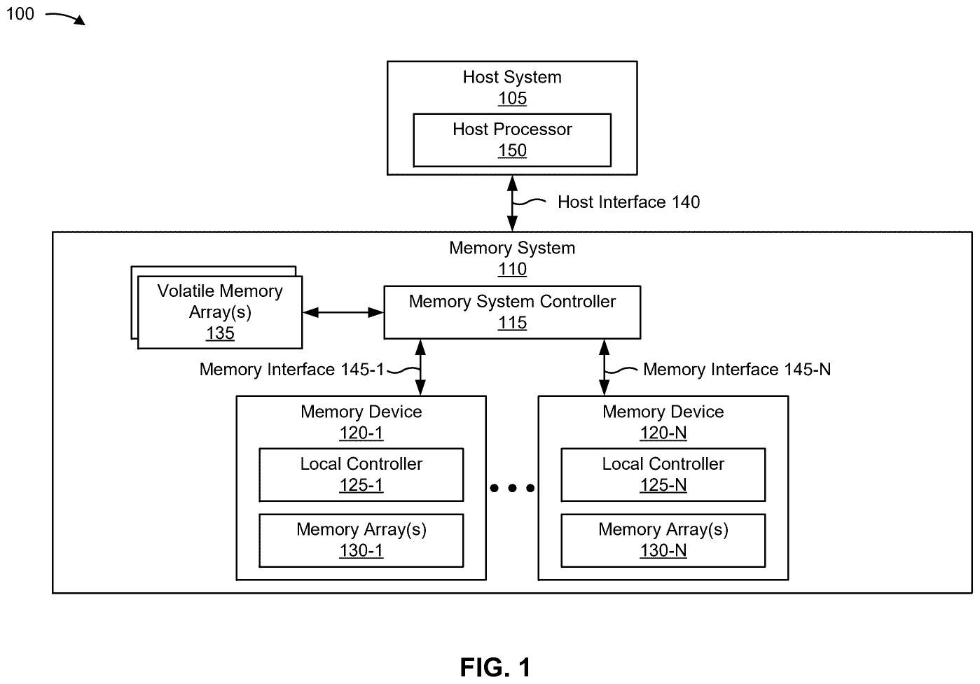

FIG. 1 is a diagram illustrating an example system 100 capable of allocating memory blocks for features during a setup of a memory device. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to allocate, during an initialization process, memory blocks in a memory for a set of features to be supported by a memory device, wherein an allocation is based on a user selection of the set of features; and reallocate, during the initialization process, remaining memory blocks that are pre-allocated in the memory for non-selected features to a pool of memory blocks.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

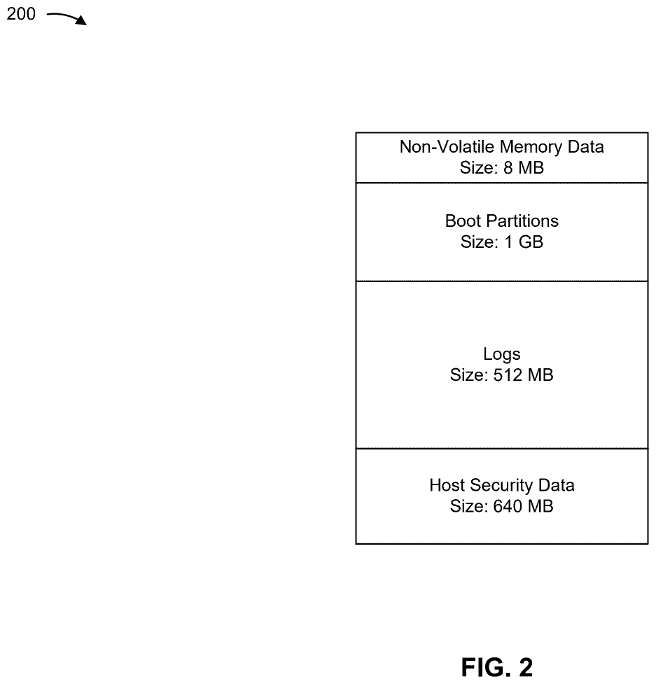

FIG. 2 is a diagram illustrating an example 200 of a statically assigned block space for specific features of a memory device.

As shown in FIG. 2, in an SSD (e.g., a multi-port automotive SSD), a typical user management feature set may include non-volatile memory data, boot partitions, logs, and/or host security data. The non-volatile memory data may include specific PCIe commands/features and/or specific NVMe commands/features. The non-volatile memory data may be approximately 8 MB in size. For the boot partitions, each port may require two partitions, which may require up to 8 slots per SSD. The boot partitions may be approximately 1 GB in size. The logs may include data for persistent events, telemetry, and other types of information. The logs may be approximately 512 MB in size. The host security data may be associated with Trusted Computing Group (TCG) support requiring a master boot record (MBR) table per function. The host security data may be approximately 640 MB in size. The non-volatile memory data, the boot partitions, the logs, and the host security data may be associated with a statically assigned block space for specific features (e.g., user management). The statically assigned block space for specific features may be part of a default setting for the multi-port automotive SSD. Other user management features requiring block space may include expansion read-only memories (ROMs) and reservation data.

However, such features may require a substantial number of memory blocks, which may be permanently allocated at design time and remain allocated for a lifetime of the memory device, regardless of whether the features are used by an application. Tradeoffs may need to be made to support the features, which may be detrimental when certain features are not intended to be used by a user of the SSD. In this situation, fewer memory blocks may be available for general purpose operations, such as read-write operations, and features associated with these memory blocks may not even be utilized.

As indicated above, FIG. 2 is provided as an example. Other examples may differ from what is described with regard to FIG. 2.

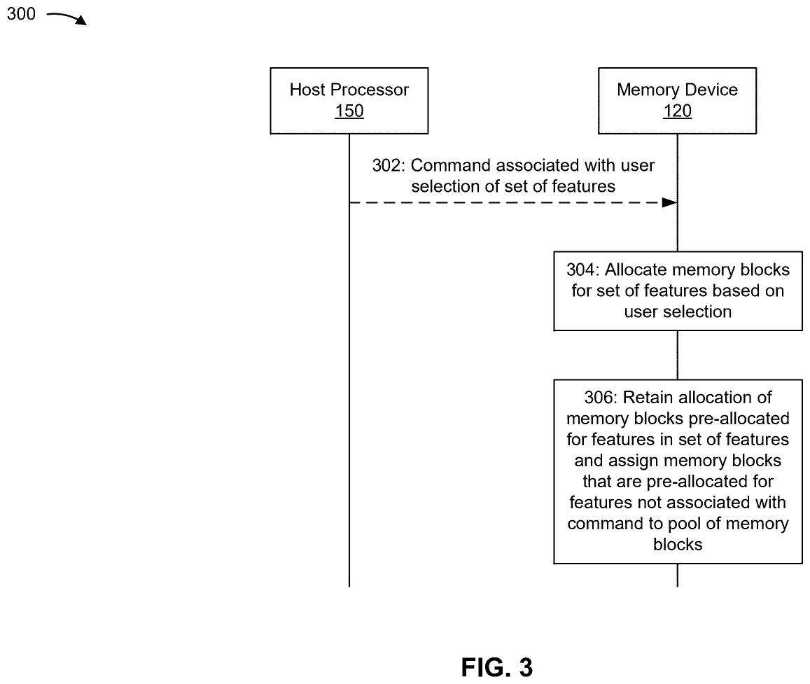

FIG. 3 is a diagram illustrating an example 300 of allocating memory blocks for features during a setup of a memory device. The example 300 may include the host processor 150 and the memory device 120. The host processor 150 and the memory device 120 may be associated with a vehicle. For example, the memory device 120 may be an automotive SSD.

In some implementations, during a setup process, the host processor 150 may provide, via a user interface, a list of sets of features (or settings). The list may indicate, for each set of features, one or more features and corresponding information. The corresponding information may include endurance information, such as total bytes of written information. The list of possible sets of features may include features associated with encryption, boot partitions, performance logs, health logs, host security data, expansion ROMs, and/or reservation data. Such features may be associated with user management requirements (or user management features).

As an example, the host processor 150 may provide, via the user interface, a list of possible feature sets. A first item on the list may be associated with a first feature not being supported and a second feature not being supported, and a corresponding endurance value. A second item on the list may be associated with the first feature not being supported and the second feature being supported, and a corresponding endurance value. A third item on the list may be associated with the first feature being supported and the second feature not being supported, and a corresponding endurance value. A fourth item on the list may be associated with the first feature being supported and the second feature being supported, and a corresponding endurance value.

In some implementations, the host processor 150 may receive, via the user interface, a selection of a certain set of features from the list. For example, the user may select a certain item on the list corresponding to certain features being supported and/or not supported.

As shown by reference number 302, the memory device 120 may receive, from the host processor 150, a command during the setup process. The command may be a vendor specific command. The command may be associated with a user selection of a set of features to be supported by the memory device 120. The user selection of the set of features to be supported by the memory device 120 may be based on the selection received via the user interface. The command may indicate that certain features are to be supported by the memory device 120. When a specific feature is not indicated by the command, an assumption may be made that the specific feature is not desired to be supported by the memory device 120. In some cases, the command may indicate that certain features are to be supported and certain features are to not be supported. In some implementations, the command may be selected from a list of predefined commands, where each command on the list of predefined commands may be associated with a predefined combination of features that are able to be supported and/or not supported by the memory device 120.

In some implementations, the memory device 120 may process the command to determine which features are to be supported and/or which features are to not be supported by the memory device 120. The memory device 120 may look up the command in a lookup table maintained by the memory device 120, and based on the lookup, the memory device 120 may be able to determine which features are to be supported and/or which features are to not be supported. For example, a first command may indicate that a first feature and a third feature are to be supported by the memory device 120. As another example, a second command may indicate that the first feature is to be supported and that a third feature is not to be supported by the memory device 120.

As shown by reference number 304, the memory device 120 may allocate, during the setup process and based on the command, memory blocks for the set of features. The memory device 120 may allocate, during the setup process, an appropriate number of memory blocks for each feature in the set of features. The memory device 120 may refrain, during the setup process, from allocating memory blocks for features that are not associated with the command. In other words, the memory device 120 may not allocate memory blocks for features that are not indicated by the command. The memory device 120 may only allocate memory blocks for selected features, and may not allocate memory blocks for features that are not selected.

As an example, four possible features may be available. A command received by the memory device 120 may indicate that a first feature and a third feature should be enabled. The memory device 120 may allocate memory blocks for only the first feature and the third feature. The memory device 120 may not allocate memory blocks for a second feature and a fourth feature, which may be based on an assumption that the second feature and the fourth feature are not intended to be used by a user associated with the memory device 120.

In some implementations, the memory device 120 may restrict modifications to a memory block allocation associated with the set of features after a completion of the setup process. Memory blocks that are allocated to certain features during the setup process may be permanent. The memory blocks may be unable to be altered after the setup process, and additional memory blocks for additional features may not be allocated after the setup process. In other words, once the memory block allocation is performed for the selected features, no modifications may be made to the memory block allocation. The memory device 120 may prevent an allocation of memory blocks associated with the selected features from being modified after the setup process is completed.

As shown by reference number 306, the memory device 120 may retain, during the setup process and based on the command, an allocation of memory blocks that are pre-allocated for features in the set of features. The memory device 120 may assign memory blocks that are pre-allocated for features that are not associated with the command to a pool of memory blocks available for general purpose usage (e.g., read-write usage). In this implementation, a plurality of memory blocks may be pre-allocated for a plurality of possible features, as part of a default configuration, during the manufacturing phase of the memory device 120. Pre-allocated memory blocks for features associated with the command may be kept after the setup process, whereas pre-allocated memory blocks for features that are not associated with the command may be reassigned to the pool of memory blocks available for general purpose usage (e.g., those memory blocks are no longer associated with any feature and instead may be used for general operations).

In some implementations, features of the plurality of possible features that are not selected via the command may no longer be available after the setup process. When memory blocks are not allocated or un-allocated for certain features during the setup process, those memory blocks may permanently become part of the pool of memory blocks available for general purpose usage and cannot revert back to being associated with the features.

In some implementations, the allocation of all possible features may be done at the manufacturing phase, and during the setup process, only the memory blocks for the selected features may be kept. Alternatively, only during the setup process, the allocation of memory blocks for the selected features may be performed.

As an example, during a design time of the memory device 120, memory blocks for four features may be allocated. These memory blocks may be pre-allocated during design time. During the setup process, a command received by the memory device 120 may indicate that a first feature and a third feature should be enabled. The memory device 120 may keep the pre-allocated memory blocks for the first feature and the third feature. The memory device 120 may un-allocate memory blocks for a second feature and a fourth feature, based on the command, such that these memory blocks may become available to support general purpose operations. These memory blocks may no longer be pre-allocated for the second feature and the fourth feature.

In some implementations, the memory device 120 may store information regarding which memory blocks are associated with which features. The information may indicate, for each possible feature, memory blocks that are associated with that feature. During allocation of certain features, the memory device 120 may be able to access those memory blocks accordingly, based on the information, to keep or reassign the memory blocks.

In some implementations, by enabling a command that allows a user to select desired features to be supported at setup time, the memory device 120 may only allocate (or retain a pre-allocation of) memory blocks for the desired features. When the user intends to use only a subset of possible features (e.g., the user does not intend to use certain features), the pre-allocation of those undesired features may be removed, thereby providing additional memory blocks that are usable for general purpose operations. In this case, since an additional number of memory blocks may be usable to support the general purpose operations, an overall performance of the memory device 120 may be improved.

In some implementations, flexibility may be provided as to which features are required by an application running on the host processor 150, and the features may be dynamically assigned at a beginning of life (time zero or at setup). By enabling the features at this time, a memory block budget may be adjusted accordingly for a use case, which may provide a better balance of customized tradeoffs versus mandatory tradeoffs built in at design time. When a user never plans to use encryption, memory blocks that may be initially set aside (or pre-allocated) for encryption may not be wasted, as those memory blocks may be reallocated for general use, and the user may not need to live with the tradeoff(s) made at design time to include encryption support in the memory device 120. A user technical documentation may offer options of features versus tradeoffs, such that the user may make an educated decision on their use of the memory device 120. While the memory device 120 is to ideally provide best-in-class capabilities for all features that are supported, in real-life scenarios, this may not be possible due to the practical constraints of NAND media. By allowing the user to select the feature set they intend to use in their application at the beginning of life, the user may get the benefit of not having to accept unnecessary tradeoffs on a memory space, over provisioning, and/or endurance, thereby mitigating tradeoffs which are made during the architecture design of the memory device 120. Feature support may be balanced with the intrinsic capabilities of the memory device 120, which may allow the user to tailor the memory device 120 to better fit their individual use case (e.g., no encryption but boot partitions are intended to be used).

In some implementations, the memory device 120 may allocate, during an initialization process, memory blocks in the memory for the set of features to be supported by the memory device 120. The set of features may include one or more features associated with encryption, boot partitions, performance logs, or health logs. An allocation may be based on the user selection of the set of features. The allocation may be based on the command that is selected from the list of predefined commands, where each command on the list of predefined commands is associated with the predefined combination of features that are able to be supported by the memory device 120. In this implementation, the allocation may not be based on the command received from the host processor 150. The memory device 120 may reallocate, during the initialization process, remaining memory blocks that are pre-allocated in the memory for non-selected features to a pool of memory blocks. The remaining memory blocks for the non-selected features may pre-allocated in the memory during the manufacturing phase of the memory device 120. The pool of memory blocks may be available for general purpose usage. The memory device 120 may restrict modifications to a memory block allocation associated with the set of features after a completion of the initialization process.

In some implementations, at time zero, when the memory device 120 is being integrated into a customer application, the user may select capabilities required and accept corresponding tradeoffs. The selection may be made through the command sent from the host processor 150 to the memory device 120. The selection may also be made during the manufacturing phase of the memory device 120 when the user's selection has already been transmitted to the memory device's manufacturer. In this case, the selection is not made via the command from the host processor 150. In some cases, the selection of the desired configuration of the memory device 120 may be made in another manner.

In some implementations, a memory device architecture may be defined that provides flexibility to the user to configure the memory device 120 in a manner which is tailored to their specific use case, which may be accomplished by dynamically allocating required non-volatile memory blocks for required features at run time. In contrast, existing memory device architectures may statically allocate required non-volatile memory blocks for required features at design time by the memory device manufacturer, thus making design choices permanent for a life of the memory device 120.

In some implementations, the memory device architecture may use firmware which is programmed to allow an end user to choose between different capabilities (e.g., encryption support, boot partitions, extended logging, etc.) of the memory device 120. Each of these choices may represent a tradeoff with the memory device's performance, endurance, reliability, etc. when selected. These tradeoffs may be acceptable to the user as the user may have a specific use case for the memory device 120, and thus the user may accept the balance of capabilities gained versus those which are degraded or removed.

As indicated above, FIG. 3 is provided as an example. Other examples may differ from what is described with regard to FIG. 3.

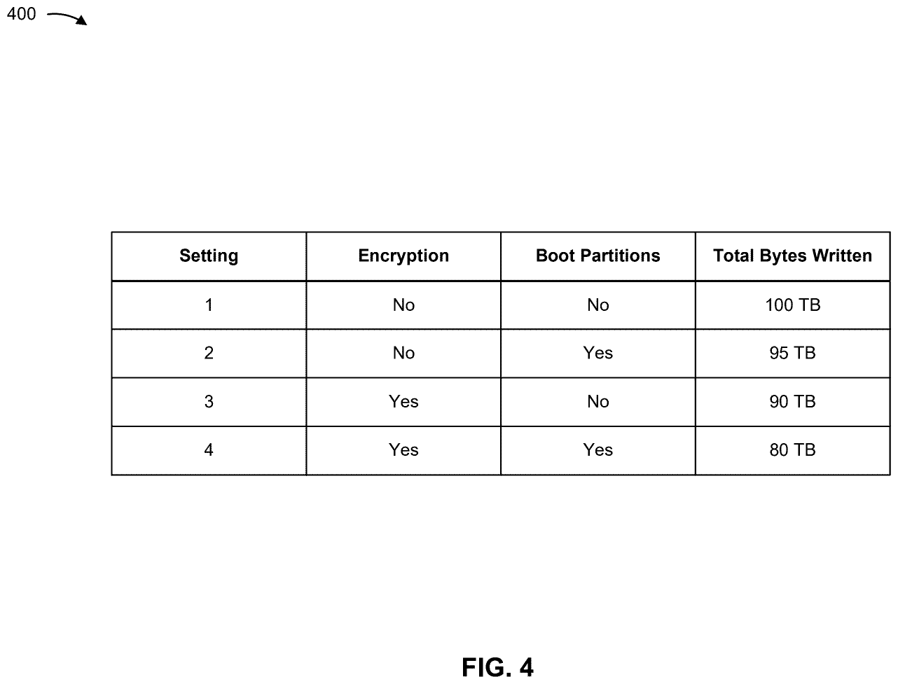

FIG. 4 is a diagram illustrating an example 400 of different sets of features available for a memory device.

As shown in FIG. 4, a first setting or feature set may involve no encryption and no boot partitions. The first setting or feature set may provide a total bytes written (an endurance metric) of 100 TB. A second setting or feature set may involve no encryption and may involve boot partitions. The second setting or feature set may provide a total bytes written of 95 TB. A third setting or feature set may involve encryption and no boot partitions. The third setting or feature set may provide a total bytes written of 90 TB. A fourth setting or feature set may involve encryption and boot partitions. The fourth setting or feature set may provide a total bytes written of 80 TB. In this example, when more features are enabled, the total bytes written may be decreased. When certain features are not intended to be used, then selecting corresponding settings or feature sets may be useful to optimize the total bytes written.

As indicated above, FIG. 4 is provided as an example. Other examples may differ from what is described with regard to FIG. 4.

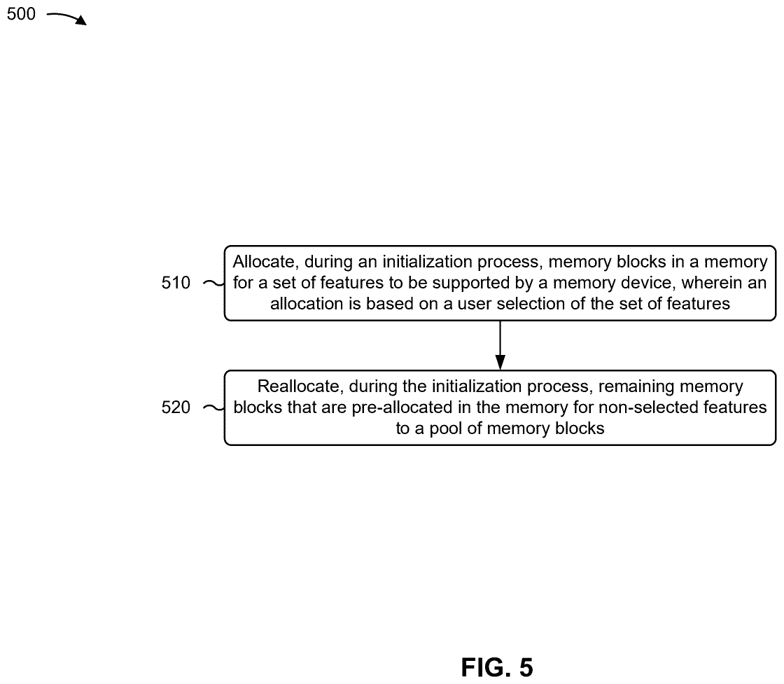

FIG. 5 is a flowchart of an example method 500 associated with allocating memory blocks for features during a setup of a memory device. In some implementations, a memory device (e.g., the memory device 120) may perform or may be configured to perform the method 500. In some implementations, another device or a group of devices separate from or including the memory device (e.g., the system 100) may perform or may be configured to perform the method 500. Additionally, or alternatively, one or more components of the memory device (e.g., the controller 125) may perform or may be configured to perform the method 500. Thus, means for performing the method 500 may include the memory device and/or one or more components of the memory device. Additionally, or alternatively, a non-transitory computer-readable medium may store one or more instructions that, when executed by the memory device (e.g., the controller 130 of the memory device 120), cause the memory device to perform the method 500.

As shown in FIG. 5, the method 500 may include allocating, during an initialization process, memory blocks in a memory for a set of features to be supported by a memory device, wherein an allocation is based on a user selection of the set of features (block 510). As further shown in FIG. 5, the method 500 may include reallocating, during the initialization process, remaining memory blocks that are pre-allocated in the memory for non-selected features to a pool of memory blocks (block 520).

The method 500 may include additional aspects, such as any single aspect or any combination of aspects described below and/or described in connection with one or more other methods or operations described elsewhere herein.

In a first aspect, the remaining memory blocks for the non-selected features are pre-allocated in the memory during a manufacturing phase of the memory device.

In a second aspect, alone or in combination with the first aspect, the pool of memory blocks is available for general purpose usage.

In a third aspect, alone or in combination with one or more of the first and second aspects, the allocation is based on a command that is selected from a list of predefined commands, wherein each command on the list of predefined commands is associated with a predefined combination of features that are able to be supported by the memory device.

In a fourth aspect, alone or in combination with one or more of the first through third aspects, the set of features includes one or more features, and the one or more features are associated with one or more of: encryption, boot partitions, performance logs, or health logs.

In a fifth aspect, alone or in combination with one or more of the first through fourth aspects, the method 500 includes restricting modifications to a memory block allocation associated with the set of features after a completion of the initialization process.

In a sixth aspect, alone or in combination with one or more of the first through fifth aspects, the memory device is associated with a vehicle.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein.

In some implementations, a memory device includes memory; and one or more components configured to: receive, from a host processor, a command during a setup process for the memory device, wherein the command is associated with a user selection of a set of features to be supported by the memory device; and allocate, during the setup process and based on the command, memory blocks in the memory for the set of features.

In some implementations, a method includes receive, by a memory device and from a host processor, a command during a setup process for the memory device, wherein the command is associated with a user selection of a set of features to be supported by the memory device; retaining, by the memory device during the setup process and based on the command, an allocation of memory blocks that are pre-allocated for features in the set of features; and assigning, by the memory device and during the setup process, memory blocks that are pre-allocated for features that are not associated with the command to a pool of memory blocks available for general purpose usage.

In some implementations, a system includes a host processor configured to: send a command associated with a user selection of a set of features; and a memory device configured to: receive, from the host processor, the command; and allocate, during a setup process of the memory device and based on the command, memory blocks in the memory device for the set of features.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same clement (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an clement that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory device, comprising:
memory; and
one or more components configured to:
allocate, during an initialization process, memory blocks in a memory for a set of features to be supported by the memory device, wherein an allocation is based on a user selection of the set of features; and
reallocate, during the initialization process, remaining memory blocks that are pre-allocated in the memory for non-selected features to a pool of memory blocks.

2. The memory device of claim 1, wherein the remaining memory blocks for the non-selected features are pre-allocated in the memory during a manufacturing phase of the memory device.

3. The memory device of claim 1, wherein the pool of memory blocks is available for general purpose usage.

4. The memory device of claim 1, wherein the allocation is based on a command that is selected from a list of predefined commands, wherein each command on the list of predefined commands is associated with a predefined combination of features that are able to be supported by the memory device.

5. The memory device of claim 1, wherein the set of features includes one or more features, and the one or more features are associated with one or more of: encryption, boot partitions, performance logs, or health logs.

6. The memory device of claim 1, wherein the one or more components are configured to:
restrict modifications to a memory block allocation associated with the set of features after a completion of the initialization process.

7. The memory device of claim 1, wherein the memory device is associated with a vehicle.

8. A method, comprising:
allocating, during an initialization process, memory blocks in a memory for a set of features to be supported by a memory device, wherein an allocation is based on a user selection of the set of features; and
reallocating, during the initialization process, remaining memory blocks that are pre-allocated in the memory for non-selected features to a pool of memory blocks.

9. The method of claim 8, wherein the remaining memory blocks for the non-selected features are pre-allocated in the memory during a manufacturing phase of the memory device.

10. The method of claim 8, wherein the pool of memory blocks is available for general purpose usage.

11. The method of claim 8, wherein the allocation is based on a command that is selected from a list of predefined commands, wherein each command on the list of predefined commands is associated with a predefined combination of features that are able to be supported by the memory device.

12. The method of claim 8, wherein the set of features includes one or more features, and the one or more features are associated with one or more of: encryption, boot partitions, performance logs, or health logs.

13. The method of claim 8, further comprising:
restricting modifications to a memory block allocation associated with the set of features after a completion of the initialization process.

14. The method of claim 8, wherein the memory device is associated with a vehicle.

15. A system, comprising:
a host processor configured to:
send a command associated with a user selection of a set of features; and
a memory device configured to:
receive, from the host processor, the command;
allocate, during a setup process of the memory device and based on the command, memory blocks in the memory device for the set of features; and
reallocate, during the setup process, remaining memory blocks that are pre-allocated in the memory for non-selected features to a pool of memory blocks.

16. The system of claim 15, wherein the host processor is configured to:
provide, via a user interface, a listing of possible settings, wherein each setting is associated with a predefined set of features and a corresponding endurance factor, wherein the endurance factor is associated with a total bytes written metric.

17. The system of claim 15, wherein the command is selected from a list of predefined commands, wherein each command on the list of predefined commands is associated with a predefined combination of features that are able to be supported by the memory device.

18. The system of claim 15, wherein the set of features includes one or more features, and the one or more features are associated with one or more of: encryption, boot partitions, performance logs, or health logs.

19. The system of claim 15, wherein the remaining memory blocks for the non-selected features are pre-allocated in the memory during a manufacturing phase of the memory device.

20. The system of claim 15, wherein the pool of memory blocks is available for general purpose usage.
